(19) United States
(12) Patent Application Publication
(10) Pub. No.: US 2004/0239797 A1
(43) Pub. Date: Dec. 2, 2004

(54) Shutter-driving device combined with a diaphragm

(75) Inventor: Atsushi Masuda, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/848,740

(22) Filed: May 19, 2004

(30) Foreign Application Priority Data
May 26, 2003 (JP) 2003-147730

(51) Int. Cl. H04N 5/235

(52) U.S. Cl. 348/362

(57) ABSTRACT

A shutter-driving device combined with a diaphragm of the present invention comprises a base member having a predetermined thickness, an aperture having a predetermined diameter and formed through the base member, and a light-adjusting member closing the aperture or adjusting the degree of opening thereof by driving a driving source. An ND filter capable of adjusting the intensity of light that passes through the aperture is supported by the base member. The movement of the ND filter is locked in a state where the aperture is not shielded when the light-adjusting member opens the aperture. In the state where the aperture is not shielded, the locking of the ND filter is released in synchronization with the operation of the light-adjusting member of closing the aperture so as to shield the aperture.

### BACKGROUND OF THE INVENTION

1. Field of the Invention

The present invention relates to a shutter-driving device combined with a diaphragm capable of also being used as a diaphragm in a digital movie camera or a digital still camera and capable of adjusting the intensity (the quantity) of light.

2. Description of the Related Art

As illustrated in FIG. 9, a conventional shutter-driving device combined with a diaphragm which is also used as a diaphragm applied to a digital movie camera or a digital still camera and which includes a neutral density (ND) filter, will be described with reference to FIGS. 9 to 14.

As illustrated in FIG. 9, in the conventional shutter-driving device combined with a diaphragm, a filter base plate 52 having a circular aperture 52a is stacked under a shutter base plate 51 in which a circular aperture 51a is formed and a first blade body 53 and a second blade body 54 are arranged between the filter base plate 52 and the shutter base plate 51.

A triangular diaphragm edge 53a that functions as the diaphragms of the apertures 51a and 52a is formed in the first blade body 53. A triangular diaphragm edge 54a in a direction reverse to that of the diaphragm edge 53a of the first blade body 53 is formed in the second blade body 54.

Further, a first driving source 55 composed of an electro-magnetic actuator for driving the first and second blade bodies 53 and 54 vertically in the drawing where the diaphragm edges 53a and 54a intersect each other is connected to one side of the shutter base plate 51. A first rocking lever 56 is rockably connected to a rotor 55a of the first driving source 55.

As illustrated in FIG. 10 that is a bottom view of FIG. 9, a holding plate 58 is arranged between the filter base plate 52 and a filter pressing plate 57 in which a rectangular aperture 57a arranged on the bottom face of the filter base plate 52 is formed.

An ND filer 59 for reducing the intensity (the quantity) of light is adhered to the lower portion of a U-shaped notch 58a. Further, a second driving source 60 composed of an electro-magnetic actuator for driving a holding plate 58 vertically in the drawing is connected to the other side of the shutter base plate 51. A second rocking lever 61 is rockably connected to a rotor 60a of the second driving source 60.

An operation in the case where the camera shutter device having the above structure is mounted on a digital movie camera will now be described with reference to FIGS. 9 to 14.

First, as a result of driving the first driving source 55 so that the rotor 55a rotates in a clockwise direction, the first and second blade bodies 53 and 54 in a position where the apertures 51a and 52a are closed as illustrated in FIG. 9 move to a position where the apertures 51a and 52a are entirely opened as illustrated in FIG. 11.

The ND filter 59 at this time is in a standby state at the position where the apertures 51a and 52a are opened as illustrated in FIG. 12.

Subsequently, when the intensity (the quantity) of light is detected by a light detection sensor (not shown) so that the intensity of light is too large (the light is too bright), diaphragm edges 53a and 54a of the first and second blade bodies 53 and 54 move in a direction in which the diaphragm edges 53a and 54a approach each other and stop when the diameter of the diaphragm is optimal as illustrated in FIG. 13.

At the point of time where the diameter of the diagram is optimal, a moving picture is photographed by an image pickup element (for example, charge-coupled device (CCD)).

Further, the ND filter 59 when the apertures 51a and 52a have the diameter of the diaphragm optimal is in a standby state as illustrated in FIG. 12.

Also, even though the above-mentioned operation of the diaphragm is performed, when the intensity (the quantity) of light cannot be adjusted to be optimal, the second driving source 60 is driven in a state where the first and second blade bodies 53 and 54 are previously held in a predetermined operation position (a predetermined diameter of the diaphragm) so that the rotor 60a illustrated in FIG. 12 is rotated in the clockwise direction.

Then, the ND filter 59 moves upward in the drawing and the apertures defined by the respective diaphragm edges 53a and 54a are covered so that the diaphragming degree is controlled to be optimal.

Subsequently, when a still picture is photographed in a state illustrated in FIG. 13 or 14 where the moving picture is photographed, the diameter of the diaphragm is already adjusted to be optimal. Therefore, when a photographer performs a release operation, charges accumulated in the CCD are discharged to perform reset (erase a recorded picture) and start exposure.

When an appropriate exposure time has passed, the rotor 55a of the first driving source 55 is driven in a counter-clockwise direction so that the apertures 51a and 52a are closed. As a result, the operation of exposure is terminated and the still picture is photographed.

[Patent Document 1]

Japanese Unexamined Patent Application Publication No. 2001-281725

Japanese Unexamined Patent Application Publication No. 2000-310803

However, since the above-mentioned conventional shutter-driving device combined with a diaphragm require the two first and second driving sources 55 and 60, power consumption may increase, which reduce the lifespan of batteries. Further, since the first and second driving sources 55 and 60 are arranged on and under the shutter base plate 51, the size of the conventional camera shutter device increases so that it is difficult to miniaturize a portable digital movie camera or digital still camera in which the shutter-driving device combined with a diaphragm is mounted.

Further, since the two first and second driving sources 55 and 60 exist, the number of parts increases so that assembling becomes complicated and manufacturing costs increase.

### SUMMARY OF THE INVENTION

The present invention has been made with consideration of the above-mentioned problems. Accordingly, it is an object of the present invention to provide a shutter-driving device combined with a diaphragm capable of being made thin and small and of driving the diaphragm and the ND filter using one driving source.

As first means for solving the above problems, there is provided a shutter-driving device combined with a diaphragm, comprising a base member having a predetermined thickness, an aperture having a predetermined diameter and formed through the base member, and a light-adjusting member closing the aperture or adjusting the degree of opening thereof by driving a driving source. An ND filter capable of adjusting the intensity (the quantity) of light that passes through the aperture is supported by the base member. The movement of the ND filter is locked in a state where the aperture is not shielded when the light-adjusting member opens the aperture. In the state where the aperture is not shielded, the locking of the ND filter is released in synchronization with the operation of the light-adjusting member of closing the aperture so as to shield the aperture.

Further, as second means for solving the above problems, the ND filter whose locking is released changes the degree of shielding the aperture in synchronization with the movement of the light-adjusting member that adjusts the degree of opening the aperture.

Further, as third means for solving the above problems, a ring-shaped driving ring that supports a part of the light-adjusting member so as to move freely is mounted on the base member. A plurality of the light-adjusting members move to the positions in which the aperture is opened and to the positions in which the aperture is closed in cooperation with the rotation of the driving ring.

Further, as fourth means for solving the above problems, the ND filter is supported by a supporting member whose one end is supported by a part of the base member on the outer circumference of the driving ring so as to freely rotate. A locking member capable of locking the movement of the supporting member in the state where the ND filter does not shield the aperture is arranged in a portion of the base member where the one end of the supporting member is positioned.

Further, as fifth means for solving the above problems, the supporting member is elastically biased by a first elastic member in a direction in which the ND filter shields the aperture and the locking member elastically biased by a second elastic member elastically contacts one end of the supporting member so that the ND filter in the state where the aperture is not shielded is locked.

Further, as sixth means for solving the above problems, the biasing force of the second elastic member is larger than the biasing force of the first elastic member.

Further, as seventh means for solving the above problems, when the locking of the supporting member by the locking member is released, the ND filter moves from the position in which the aperture is not shielded to the position in which the aperture is shielded by the biasing force of the first elastic member.

Further, as eighth means for solving the above problems, a unlocking portion capable of rotating the driving ring in a direction in which the light-adjusting member closes the aperture so that the locked supporting member is pressed to release the locking of the supporting member is formed in the driving ring.

Further, as ninth means for solving the above problems, the supporting member rotates in synchronization with the rotation of the driving ring in the direction in which the light-adjusting member opens the aperture so that the ND filter moves from the position in which the aperture is shielded to the position in which the aperture is not shielded.

Further, as tenth means for solving the above problems, an operation pin capable of moving the ND filter from the state where the aperture is shielded to the position in which the aperture is not shielded against the biasing force of the first elastic member is formed in the driving ring.

Further, as eleventh means for solving the above problems, the driving source includes an electromagnetic actuator. The driving ring rotates at a predetermined angle of rotation in cooperation with the reciprocating motion of a driving lever directly connected to the driving source in one direction and in the other direction.

Further, as twelfth means for solving the above problems, an engaging groove with which the driving lever engages is formed in the driving ring. Elongated holes with which protrusions formed in the driving ring engage are formed in the plurality of light-adjusting members. The driving lever engaging with the engaging groove of the driving ring engages with the elongated hole of the one light-adjusting member. The protrusions formed in the driving ring engage with the elongated holes of the remaining light-adjusting members.

### BRIEF DESCRIPTION OF THE DRAWINGS

FIG. 1 is an exploded perspective view of a shutter-driving device combined with a diaphragm according to the present embodiment;

FIG. 2 is a plan view of a base member according to the present invention;

FIG. 3 is an enlarged view illustrating main portions illustrating the operation of the shutter-driving device combined with a diaphragm according to the present invention;

FIG. 4 is an enlarged view illustrating main portions illustrating the operation of the shutter-driving device combined with a diaphragm according to the present invention;

FIG. 5 is an enlarged view of main portions illustrating the operation of the shutter-driving device combined with a diaphragm according to the present invention.

FIG. 6 is an enlarged view of main portions illustrating the operation of the shutter-driving device combined with a diaphragm according to the present invention;

FIG. 7 is an enlarged view of main portions illustrating the operation of the shutter-driving device combined with a diaphragm according to the present invention;

FIG. 8 is an enlarged view of main portions illustrating the operation of the shutter-driving device combined with a diaphragm according to the present invention;

FIG. 9 is a schematic view illustrating a conventional shutter-driving device combined with a diaphragm;

FIG. 10 is a schematic view illustrating a conventional shutter-driving device combined with a diaphragm;

FIG. 11 is a schematic view illustrating the operation of a conventional shutter-driving device combined with a diaphragm;

FIG. 12 is a schematic view illustrating the operation of a conventional shutter-driving device combined with a diaphragm;

FIG. 13 is a schematic view illustrating the operation of a conventional shutter-driving device combined with a diaphragm; and

FIG. 14 is a schematic view illustrating the operation of a conventional shutter-driving device combined with a diaphragm.

### DESCRIPTION OF THE PREFERRED EMBODIMENTS

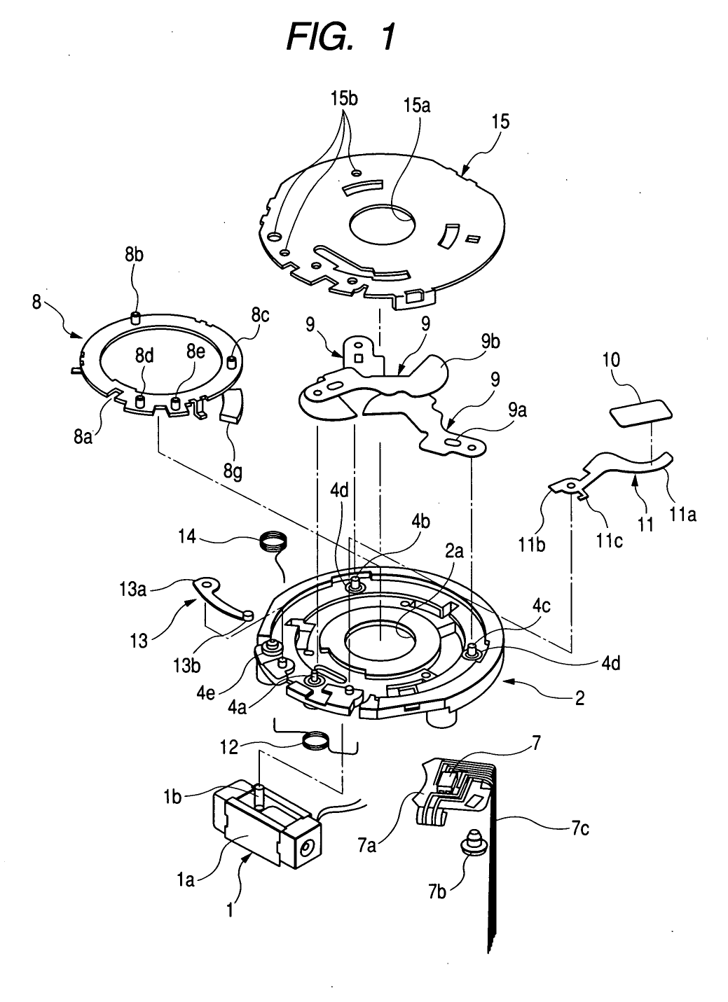

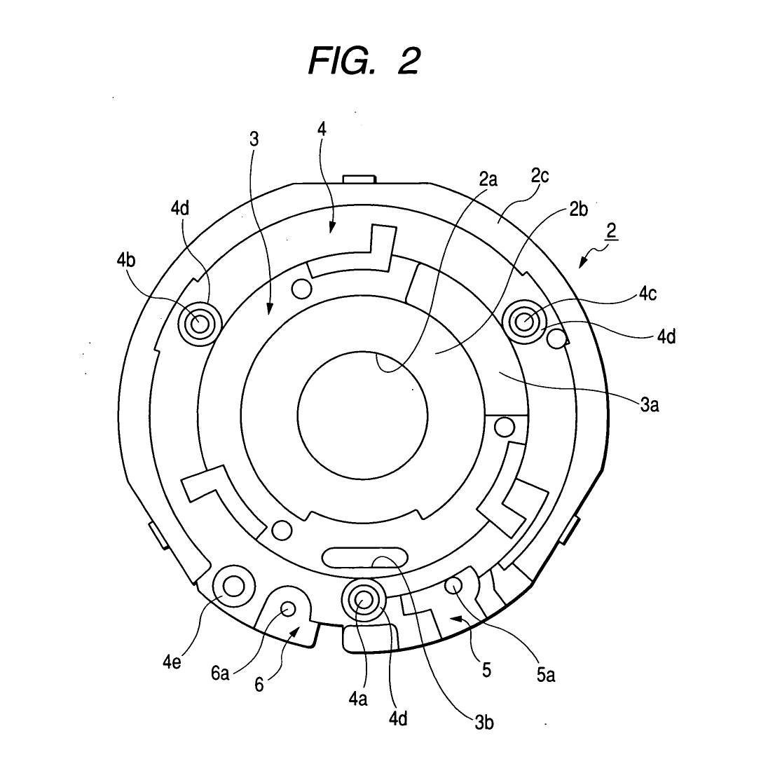

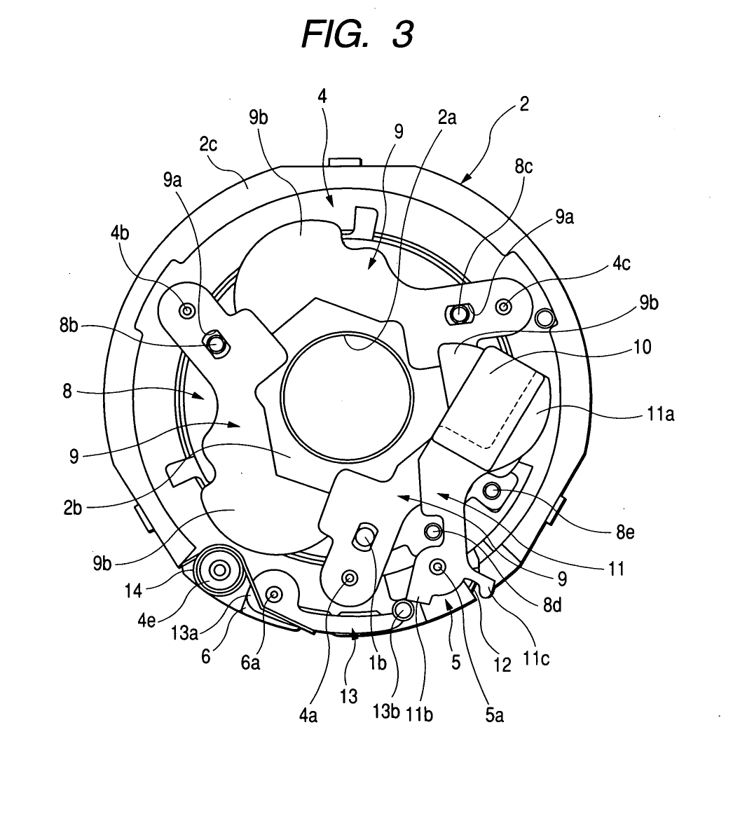

Embodiments of a shutter-driving device combined with a diaphragm according to the present invention will now be described with reference to the present invention. FIG. 1 is an exploded perspective view of the shutter-driving device combined with a diaphragm according to the present invention. FIG. 2 is a plan view of a base member according to the present invention. FIGS. 3 to 8 are enlarged views of main portions illustrating the operation of the shutter-driving device combined with a diaphragm according to the present invention.

First, according to the shutter-driving device combined with a diaphragm of the present embodiment, as illustrated in FIG. 1, a driving source 1 for reciprocating and rotating a driving ring 8 that will be mentioned later at a predetermined angle is arranged at the lowermost portion.

The driving source 1 includes an electromagnetic actuator (not shown) in which a permanent magnet, a coil, and a driving rod are arranged in a case 1a. Through holes are formed in the centers of the permanent magnet and the coil and the driving rod is arranged in the through holes.

Also, the driving rod can reciprocate in one direction and in the other direction by a magnetic field generated by flowing predetermined current through a coil.

Further, a driving lever 1b is fixed to the driving rod and is arranged so as to extend from the case 1a to the outside. The driving lever 1b reciprocates as the result of the reciprocating motion of the driving rod.

The driving source 1 is fixed to the rear side of the base member 2 made of resin, whose outward appearance is substantially circular, by a small screw (not shown).

The base member 2 is made of the resin. As illustrated in FIG. 2, the outward appearance of the base member 2 is substantially circular. A circular aperture 2a of a predetermined size is formed through the center of the base member 2. A ring-shaped protruding blade sliding surface 2b whose surface is flat is formed around the aperture 2a. A surrounding wall 2c is formed to have predetermined width and height in the outer circumference of the base member 2.

A ring-shaped concave portion 3 of a predetermined depth is engraved outside the blade sliding surface 2b. A driving ring 8 that will be mentioned later is located in the concave portion 3 so as to freely rotate.

As illustrated in FIG. 2, a fan-shaped sensor hole 3a along the ring-shaped concave portion 3 at the inclined upper right in the drawing and a slit-shaped driving hole 3b of predetermined width and length at the proximal side in the drawing are formed through the bottom of the concave portion 3.

The driving lever 1b of the driving source 1 is inserted through the driving hole 3b from the rear side of the base member 2 as to reciprocate through the driving hole 3b from one side thereof to the other side thereof.

Further, a ring-shaped first supporting surface 4 slightly lower than the blade sliding surface 2b and higher than the bottom face of the concave portion 3 is formed outside the concave portion 3. Three first supporting protrusions 4a, 4b, and 4c are formed at positions having equal intervals of 120° on the first supporting surface 4 so as to protrude to a predetermined height.

Further, small ring-shaped blade receiving portions 4d that protrude to the same height as that of the blade sliding surface 2b are formed around the respective first supporting protrusions 4a, 4b, and 4c so as to surround the first supporting protrusions 4a, 4b, and 4c.

Further, a two-stage spring supporting protrusion 4e is formed so as to protrude above the first supporting surface 4 around a third supporting protrusion 6a that will be mentioned later in the clockwise direction.

Further, a second supporting surface 5 slightly higher than the first supporting surface 4 is formed around the proximal first supporting protrusion 4a illustrated in FIG. 2 in the counter-clockwise direction. A second supporting protrusion 5a having almost the same diameter as that of the first supporting protrusions 4a, 4b, and 4c is formed on the second supporting surface 5 so as to protrude to a predetermined height.

Further, a third supporting surface 6 having almost the same height as that of the second supporting surface 5 is formed around the first supporting protrusion 4a illustrated in FIG. 2 in the clockwise direction in the drawing. The third supporting protrusion 6a having almost the same diameter as that of the first supporting protrusions 4a, 4b, and 4c is formed on the third supporting surface 6 so as to protrude to a predetermined height.

As illustrated in FIG. 1, a sensor board 7a to which a magnetic sensor 7 composed of a Hall element is attached to the rear side of the base member 2 in the portion of the sensor hole 3a formed in the concave portion 3 by the small screw 7b. Further, a flexible print circuit board 7c is connected to the sensor board 7a. The FPC 7c may also be used as the sensor board 7a.

Further, the driving ring 8 whose outward appearance is ring-shaped is arranged in the ring-shaped concave portion 3 so as to freely rotate. A U-shaped engaging groove 8a of a predetermined width is formed toward the center of the ring in the outer circumference of the driving ring 8 at the inclined lower left in the drawing. The driving lever 1b of the driving source 1 engages with the engaging groove 8a and the driving power of the driving source 1 is transmitted through the driving lever 1b so that the driving ring 8 can rotate at a predetermined angle.

Further, two fourth supporting protrusions 8b and 8c are formed in the driving ring 8 so as to protrude to a predetermined height. The two fourth supporting protrusions 8b and 8c and the engaging groove 8a are formed so as to be separated from each other by the same distance at intervals of 120° .

Further, an operation pin 8d and a unlocking pin 8e that is a unlocking portion are formed in the driving ring 8 at the proximal side in the drawing around the engaging groove 8a so as to be separated from each other by a predetermined distance and to protrude to a predetermined height.

Further, a sensor magnet 8g is fixed to the rear side of the driving ring 8 in the portion located on the sensor hole 3a of the concave portion 3 with an adhesive, etc.

When the driving ring 8 is assembled into the concave portion 3 in a state where the engaging groove 8a is aligned on the driving hole 3b of the base member 2 and the sensor magnet 8g is aligned on the sensor hole 3a, the driving lever 1b of the driving source 1, which protrudes above the driving hole 3b, is inserted through the engaging groove 8a. Also, the sensor magnet 8g faces the magnetic sensor 7.

Therefore, when the driving source 1 is driven so that the driving lever 1b reciprocates in one direction and in the other direction along the driving hole 3b, the driving ring 8 rotates in the clockwise and counter-clockwise directions at a predetermined angle.

Further, the distance of the movement of the driving rod of the driving source 1 is controlled by the magnetic sensor 7 for detecting changes in the intensity of the magnetic field of the sensor magnet 8g to control the angle of rotation of the driving ring 8.

Further, one end of each of three light-adjusting members 9 composed of thin plate-shaped diaphragm blades is supported by the three first supporting protrusions 4a, 4b, and 4c of the first supporting surface 4 so as to freely rotate.

In the light-adjusting members 9, elongated oval grooves 9a are separated from the positions in which the light-adjusting members 9 are supported by each of the first supporting protrusions 4a, 4b, and 4c by a predetermined distance to the inside.

Further, blade portions 9b of a predetermined size, which are capable of closing the aperture 2a, are formed in the other ends of the light-adjusting members 9.

The one end of each of the three light-adjusting members 9 is supported by each of the first supporting portions 4a, 4b, and 4c. The fourth supporting protrusions 8b and 8c of the driving ring 8 are fitted into the elongated holes 9a of the two light-adjusting members 9. The driving lever 1b of the driving source 1 that is inserted through the engaging groove 8a of the driving ring 8 upward engages with the elongated hole 9a of the one light-adjusting member 9.

Therefore, the driving power of the driving source 1 is transmitted to the driving ring 8 through the driving lever 1b so that the driving ring rotates and that the movement of the driving lever 1b is directly transmitted to the light-adjusting member 9 with which the driving lever 1b engages.

Further, the other two light-adjusting members 9 rotate in a direction in which the blade portions 9b close the aperture 2a or in a direction in which the blade portions 9b open the aperture 2a through the rotating driving ring 8.

When the two light-adjusting members 9 rotate in the direction where the blade portions 9b close the aperture 2a, as illustrated in FIG. 5, the respective blade portions 9b overlap each other so that the light-adjusting members 9 close the aperture 2a.

When the driving ring 8 is rotated in the counter-clockwise direction while the light-adjusting members 9 close the aperture 2a, the blade portions 9b of the respective light-adjusting members 9 are synchronized with each other to rotate in the direction of opening the aperture 2a so that the light-adjusting members 9 open the aperture 2a as illustrated in FIG. 3.

Further, a neutral density (ND) filter 10 capable of reducing the intensity (the quantity) of the light that passes through the aperture 2a by shielding the aperture 2a is arranged. The ND filter 10 is supported by the other end 11a of a supporting member 11.

One end 11b of the supporting member 11 on the left side in the drawing is supported by the second supporting protrusion 5a that is a part of the base member 2 so as to freely rotate.

Further, a spring locking portion 11c is formed in the supporting member 11 so as to protrude outward. One end of a first elastic member 12 composed of a torsional coil spring is locked to the spring locking portion 11c. The other end of the first elastic member 12 is locked to the base member 2.

Also, the supporting member 11 is always elastically biased in a direction in which the ND filter 10 closes the aperture 2a.

Further, a locking member 13 capable of regulating the movement of the supporting member 11 that supports the ND filter 10 to lock the supporting member 11 is supported by the third supporting protrusion 6a of the base member 2.

In the locking member 13, one end 13a on the left side of the drawing is supported by the third supporting protrusion 6a and the other end 13b on the right side of the drawing elastically contacts the one end 11b of the supporting member 11.

A second elastic member 14 composed of a torsional coil spring and having a biasing force larger than that of the first elastic member 12 is supported by the spring supporting protrusion 4e of the base member 2.

In the second elastic member 14, the left end illustrated in FIG. 3 is supported by the base member 2 and the right end illustrated in FIG. 3 elastically biases the back of the locking member 13.

Therefore, the locking member 13 is elastically biased in the counter-clockwise direction in the drawing using the third supporting protrusion 6a as a fulcrum and the other end 13b of the locking member 13 elastically contacts the one end 11b of the supporting member 11 so that the movement of the supporting member 11 is locked against the biasing force of the first elastic member 12.

Further, a cover member 15 made of a metal plate is arranged on the surrounding wall 2c of the base member 2. An aperture 15a having almost the same size as that of the aperture 2a is formed through the center of the cover member 15 that faces the aperture 2a of the base member 2. A plurality of supporting holes 15b into which the first, second, and third supporting protrusions 4a, 4b, 4c, 5a, and 6a of the base member 2 can be fitted is formed through the cover member 15.

Also, a cover member 15 is placed from the upper side of the base member 2 on which the driving ring 8, the light-adjusting members 9, the ND filter 10 supported by the supporting member 11, and the locking member 13 are put. The cover member 15 is snapped to the base member 2 in a state where the first, second, and third supporting protrusions 4s, 4b, 4c, 5a, and 6a protrudes from the respective supporting holes 15b so that the shutter-driving device combined with a diaphragm according to the present invention is assembled.

The operation of the shutter-driving device combined with a diaphragm according to the present invention mounted in the digital movie camera or the digital still camera will now be described. The light-detecting sensor capable of detecting the intensity (the quantity) of the light that passes through the aperture 2a is arranged in the camera.

Further, a relationship between the value of the voltage output from the magnetic sensor 7 and the angle of rotation of the driving ring 8, that is, a relationship between the value of the voltage output from the magnetic sensor 7 and the diameter of the diaphragm of the aperture 2a in accordance with the three light-adjusting members 9 is previously input to a control unit (not shown) as a control map.

First, when a moving picture is photographed by the digital movie camera, when a photographer operates a power button, the driving source 1 illustrated in FIG. 1 starts so that the driving rod (not shown) move to the proximal (lower) side in the drawing and that the driving lever 1b directly connected to the driving rod is also moved to the proximal side.

The driving ring 8 rotates in the counter-clockwise direction at a predetermined angle in synchronization with the movement of the driving lever 1b so that the blade portions 9b of the three light-adjusting members 9 rotate to the outside to move to the position in which the aperture 2a is opened as illustrated in FIG. 3.

As the driving ring 8 rotates in the counter-clockwise direction, the supporting member 11 that supports the ND filter 10 is biased to the outside against the biasing force of the first elastic member 12 with the operation pin 8d of the driving ring 8 to rotate in the clockwise direction using the second supporting protrusion 5a as a fulcrum.

With the rotation of the supporting member 11 in the clockwise direction, the one end 11b elastically contacts the other end 13b of the locking member 13 to lock the movement of the supporting member 11. That is, the movement of the ND filter 10 is locked in a state that the aperture 2a is not shielded.

In a state that the ND filter 10 is in a state where the aperture 2a is not shielded and that the light-adjusting members 9 are at the positions where the aperture 2a is opened, for example, when the photographer operates a button for photographing a moving picture, the driving lever 1b directly connected to the driving rod of the driving source 1 moves to the inside as illustrated in FIG. 1 so that the driving ring 8 rotates in the clockwise direction.

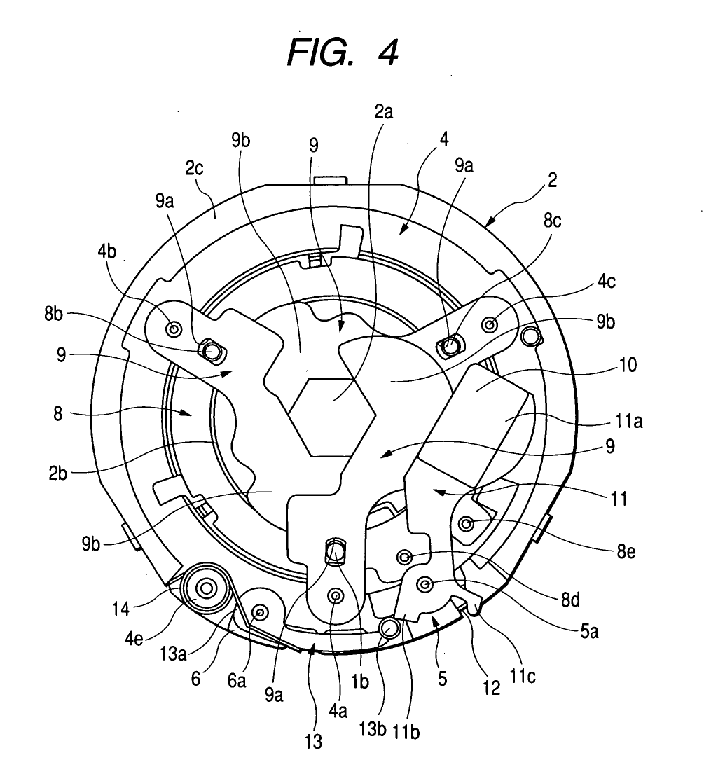

Then, at the point of time where the aperture 2a is diaphragmed by the blade portions 9b of the three light-adjusting members 9 by a predetermined quantity as illustrated in FIG. 4 so that the intensity (the quantity) of the light that passes through the aperture 2a and that is detected by the light-detecting sensor is optimal for photographing, the moving picture is photographed by an image pickup element (for example, a charge coupled device (CCD)).

The moving picture is photographed by continuous one-frame shooting of repeating the operation of discharging the charges accumulated in the image pickup element.

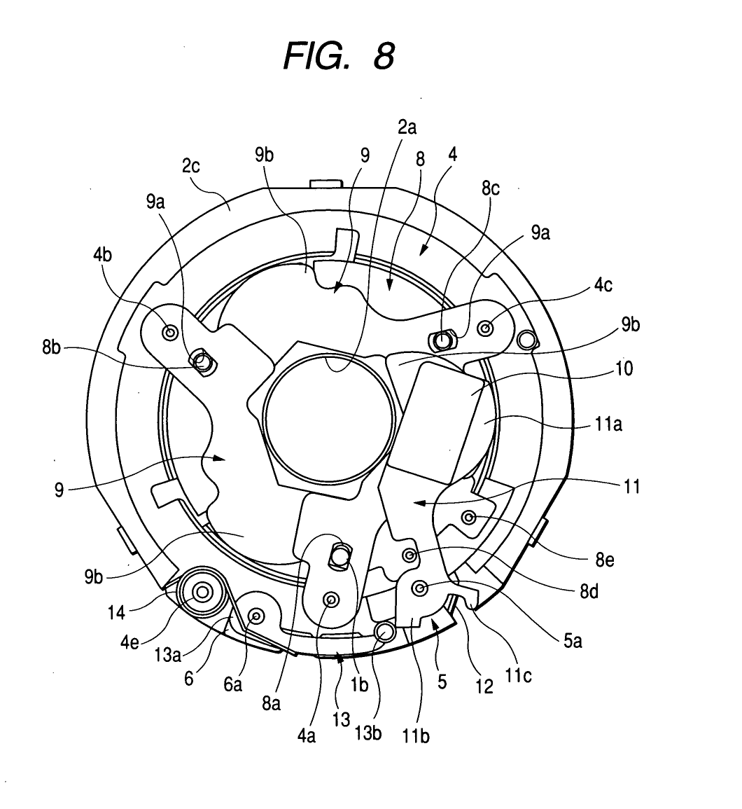

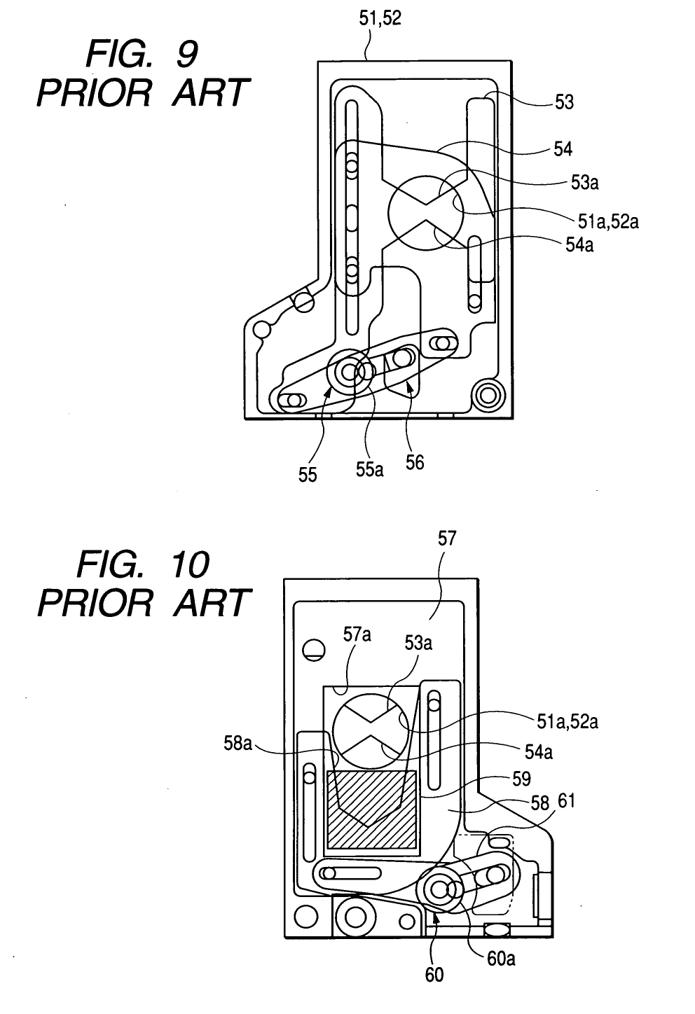

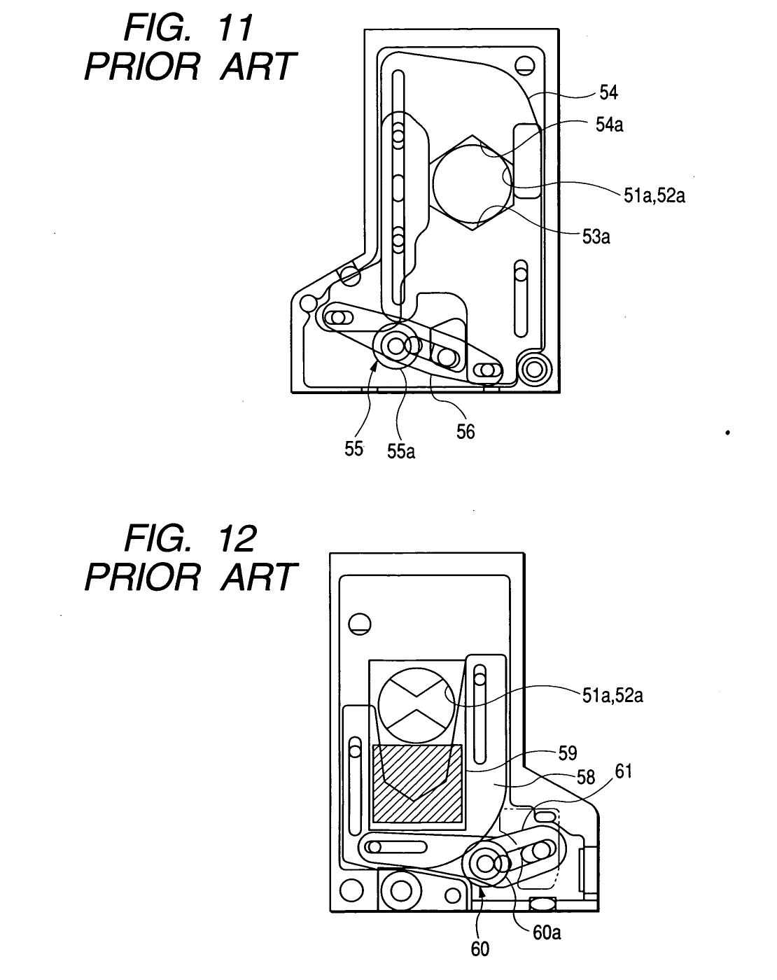

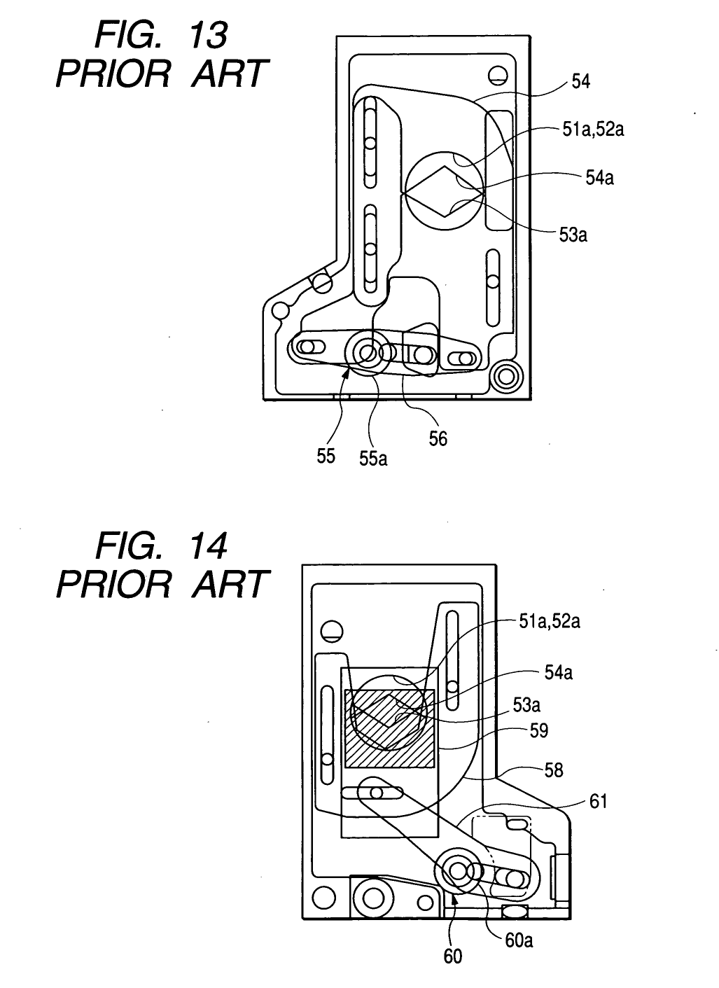

When the photographed subject is dark, as illustrated in FIG. 8, it is possible to photograph a desired picture by rotating the light-adjusting members 9 to the outside to be at the positions where the aperture 2a is opened.

However, even though the subject is bright, even if a diaphragming operation of rotating the light-adjusting members 9 to the positions where the aperture 2a is closed is performed, when the intensity of the light that passes through the aperture 2a is too large so that it is not possible to adjust the optimal exposure, the aperture 2a diaphragmed by the light-adjusting members 9 shielded with the ND filter 10 to adjust the exposure.

According to the exposure using the ND filter 10, first, when the driving ring 8 is rotated in the clockwise direction from the state in which the aperture 2a is diaphragmed as illustrated in FIG. 4, as illustrated in FIG. 5, the respective blade portions 9b of the light-adjusting members 9 rotate to the inside so that the light-adjusting members 9 move to the positions where the aperture 2a is completely closed.

Further, the unlocking pin 8e of the driving ring 8 illustrated in FIG. 5 presses the supporting member 11 to the left side in the drawing by rotating the driving ring 8 in the clockwise direction to release the locking of the supporting member 11 by the locking member 13.

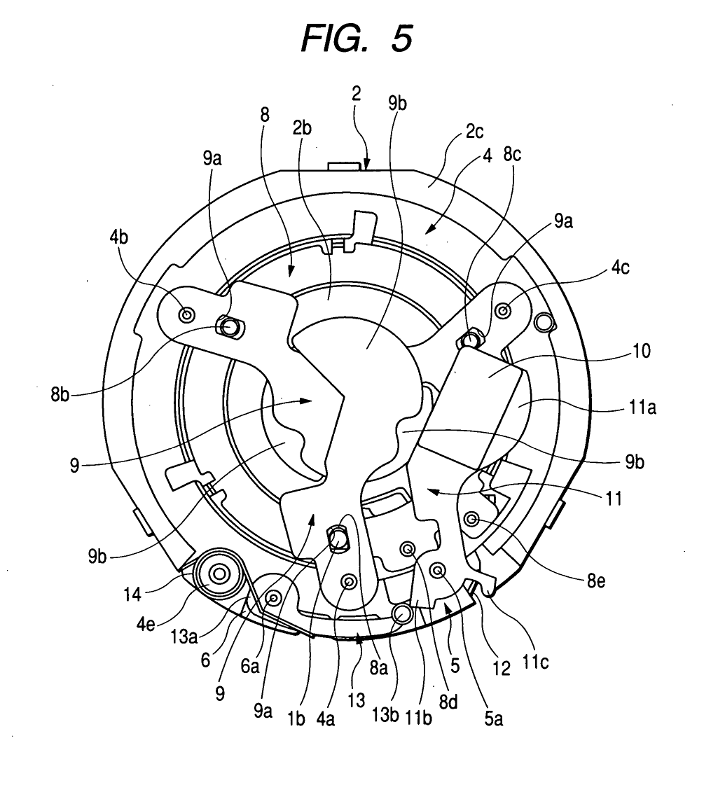

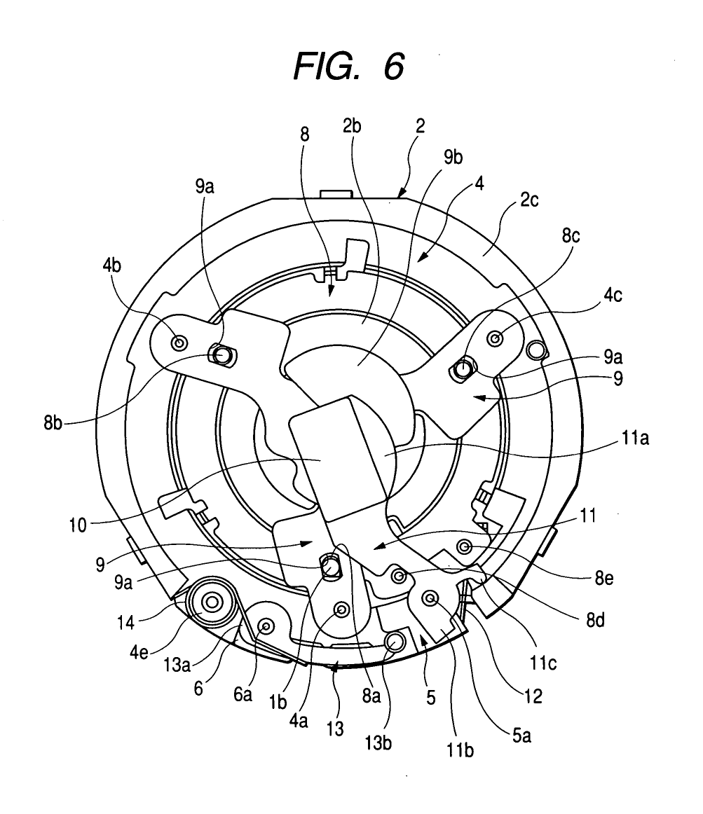

Therefore, the supporting member 11 rotates in the counter-clockwise direction using the second supporting protrusion 5a as fulcrum by the biasing force of the first elastic member 12. The ND filter 10 is positioned on the respective blade portions 9b in a state where the aperture 2a is closed as illustrated in FIG. 6.

At this time, the supporting member 11 that supports the ND filter 10 abuts on the operation pin 8d so that the supporting member 11 does not rotate in the counter-clockwise direction any more.

Thereafter, the driving ring 8 is reverse rotated in the counter-clockwise direction so that the light-adjusting members 9 that have been closed the aperture 2a move to the outside to open the aperture 2a. Further, the driving ring 8 rotates in the counter-clockwise direction so that the supporting member 11 is pressed by the operation pin 8d to rotate in the clockwise direction. Therefore, the aperture 2a opened to a predetermined degree is shielded by the ND filter 10.

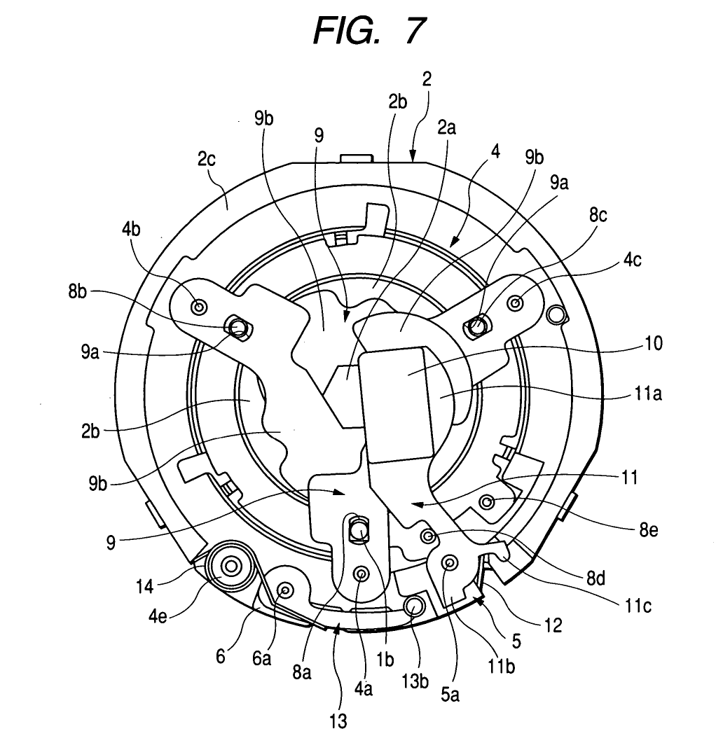

Moreover, the ND filter 10 in FIG. 7 shields substantially half of the aperture 2a opened to the predetermined degree. However, it is also possible to shield the entire aperture 2a opened to the predetermined degree by changing the position of the operation pin 8d that presses the supporting member 11 in the counter-clockwise direction.

While the intensity (the quantity) of the light that passes through the aperture 2a shielded by the ND filter 10 is monitored by the light-detecting sensor, the driving of the driving source 1 is controlled based on the control map so that the rotating driving ring 8 automatically stops at the position where the diaphragming degree of the aperture 2a is optimal. Then, the continuous one-frame shooting is performed by the image pickup element to photograph the moving picture.

In the moving picture photographing mode, the light-adjusting members 9 can rotate from the positions in which the aperture 2a is closed as illustrated in FIG. 6 to the positions in which the aperture 2a is opened as illustrated in FIG. 8, and the locking of the ND filter 10 by the locking member 13 is released. Therefore, the ND filter 10 can move to the position in which the aperture 2a is shielded and to the position in which the aperture 2a is not shielded in synchronization with the movement of the light-adjusting members 9.

Subsequently, when the still picture is photographed in the state illustrated in FIG. 7 where the moving picture is photographed, since the aperture 2a is adjusted to have the optimal diameter of the diaphragm, the operator operates a still picture button so that the charges accumulated in the image pickup element are discharged and that reset is performed to start the operation of exposure.

After the lapse of a predetermined time, the driving source 1 is driven by a signal from the control unit to rapidly rotate the driving ring 8 in the clockwise direction so that the operation of exposure is stopped and the still picture is photographed by the operation of a shutter in which the light-adjusting members 9 shields the aperture 2a.

Further, when the still picture is photographed by the digital still camera, in a pause state before the driving source 1 starts, as illustrated in FIG. 6, the light-adjusting members 9 are at the positions where the aperture 2a is closed, and the locking of the ND filter 10 is released so that the aperture 2a is shielded.

Then, when the photographer performs a release operation, the light-adjusting members 9 rotate to the outside with the rotation of the driving ring 8 to move to the positions where the aperture 2a is opened as illustrated in FIG. 3, and the supporting member 11 that supports the ND filter 10 is pressed by the operation pin 8d to rotate in the clockwise direction and is locked by the locking member 13.

In this state, the light-detecting sensor controls the driving of the driving source 1 while monitoring the intensity (the quantity) of the light that passes through the aperture 2a so that the operation of exposure is performed at the position where the diaphragming degree of the aperture 2a is optimal as illustrated in FIG. 4 and that the light-adjusting members 9 move to the positions where the aperture 2a is closed as illustrated in FIG. 5 to photograph the still picture.

Further, when the still picture is photographed by the digital still camera, in the case where the intensity of the light monitored by the light-detecting sensor is too large, the light-adjusting members 9 are moved to the positions where the aperture 2a is closed so that the locking of the ND filter 10 by the locking member 13 is released and that the aperture 2a whose diaphragming degree is adjusted to a predetermined degree is closed by the ND filter 10 to photograph the still picture.

Further, in the embodiment of the present invention, the electro-magnetic actuator that reciprocates the driving lever 1b is used as the driving source 1. However, a motor may be used as a driving source, an arcuate rack may be attached to the driving ring 8 along the circumference of the driving ring 8, and a pinion gear may mesh with the rack so that the driving ring 8 is rotated by rotating the motor from side to side.

In the above-mentioned shutter device combined with a diaphragm according to the present invention, the light-adjusting members 9 and the ND filter 10 are manipulated by rotating the driving ring 8 using one driving source 1 to photograph an optimal picture. Therefore, it is possible to realize a shutter device combined with a diaphragm capable of reducing the number of parts, of easily performing assembling, and of being made thin.

Further, in the embodiment of the present invention, the number of light-adjusting members 9 is three. However, the number of light-adjusting members 9 may be two or four.

As mentioned above, the movement of the ND filter according to the present invention is locked in a state where the aperture is not shielded when the light-adjusting member opens the aperture. In the state where the aperture is not shielded, the locking of the ND filter is released in synchronization with the operation of the light-adjusting member of closing the aperture to shield the aperture. Therefore, it is possible to operate the light-adjusting member and the ND filter using one driving source and to provide a shutter-driving device combined with a diaphragm capable of reducing power consumption and of prolonging the lifespan of batteries.

Further, since only one driving source is used, it is possible to miniaturize the shutter-driving device combined with a diaphragm and to reduce the number of parts. As a result, it is possible to easily perform assembling.

Further, the ND filter whose locking is released changes the degree of shielding the aperture in synchronization with the movement of the light-adjusting member that adjusts the degree of opening the aperture. Therefore, when the subject is bright and thus the diaphragming quantity is large, the degree of shielding the aperture by the ND filter increases. When the subject has a predetermined brightness, the degree of shielding the aperture by the ND filter is reduced so that it is possible to perform optimal exposure using one driving source.

Further, since a plurality of the light-adjusting members move to the positions where the aperture is opened and to the positions where the aperture is closed in cooperation with the rotation of the driving ring, it is possible to linearly diaphragm the aperture from the positions in which the aperture is opened to the positions in which the aperture is closed.

Further, since the locking member capable of locking the movement of the supporting member in the state where the ND filter does not shield the aperture is arranged in a portion of the base member where one end of the supporting member that supports the ND filter is positioned, the locking member locks the ND filter when the ND filter is not required and the locking by the locking member is released when the ND filter is required allowing the shielding of the aperture by the ND filter.

Therefore, it is possible to appropriately photograph subjects having different brightness.

Further, since the supporting member is elastically biased by the first elastic member in the direction in which the ND filter shields the aperture and the locking member elastically biased by the second elastic member elastically contacts one end of the supporting member so that the ND filter in the state where the aperture is not shielded is locked, it is possible to simply lock and unlock the supporting member that supports the ND filter.

Further, since the biasing force of the second elastic member is larger than the biasing force of the first elastic member, it is possible to firmly lock the supporting member that supports the ND filter.

Further, when the locking of the supporting member by the locking member is released, the ND filter moves from the position where the aperture is not shielded to the position where the aperture is shielded by the biasing force of the first elastic member so that it is possible to firmly shield the aperture by the ND filter whose locking is released.

Further, since a unlocking portion capable of releasing the locking of the supporting member by rotating the driving ring in the direction in which the light-adjusting member is rotated to the positions where the aperture is closed to press the locked supporting member is formed in the driving ring, it is possible to firmly release the locking of the locked supporting member.

Further, since the ND filter moves from the position in which the aperture is shielded to the position in which the aperture is not shielded by rotating the supporting member in synchronization with the rotation of the driving ring by which the light-adjusting member rotate to the positions where the aperture is opened, it is possible to manipulate the light-adjusting member and the ND filter using one driving source.

Further, since an operation pin capable of moving the ND filter at the position where the aperture is shielded to the position in which the aperture is not shielded against the biasing force of the first elastic member is formed in the driving ring, it is possible to easily lock the ND filter whose locking is released by the operation pin and to improve operability.

Further, since the driving source includes the electromagnetic actuator and the driving ring rotates at a predetermined angle of rotation in cooperation with the reciprocating motion of the driving lever directly connected to the driving source in one direction and in the other direction, it is possible to provide a shutter-driving device combined with a diaphragm capable of manipulating the light-adjusting member and the ND filter by rotating the driving ring using one driving source and of reducing the number of parts, which reduce manufacturing costs.

1. A shutter-driving device combined with a diaphragm, comprising:
a base member having a predetermined thickness;
an aperture having a predetermined diameter and formed through the base member; and
a light-adjusting member closing the aperture or adjusting a degree of opening thereof by driving a driving source,
wherein an ND filter capable of adjusting a intensity of light that passes through the aperture is supported by the base member,
wherein movement of the ND filter is locked in a state where the aperture is not shielded when the light-adjusting member opens the aperture, and
wherein, in a state where the aperture is not shielded, the locking of the ND filter is released in synchronization with the operation of the light-adjusting member of closing the aperture so as to shield the aperture.

2. The shutter-driving device combined with a diaphragm according to claim 1, wherein the ND filter whose locking is released changes a degree of shielding the aperture in synchronization with movement of the light-adjusting member that adjusts the degree of opening the aperture.

3. The shutter-driving device combined with a diaphragm according to claim 1,
wherein a ring-shaped driving ring that supports a part of the light-adjusting member so as to move freely is mounted on the base member, and
wherein a plurality of the light-adjusting members move to positions in which the aperture is opened and to positions in which the aperture is closed in cooperation with rotation of the driving ring.

4. The shutter-driving device combined with a diaphragm according to claim 1,
wherein the ND filter is supported by a supporting member whose one end is supported by a part of the base member on an outer circumference of a driving ring so as to freely rotate, and
wherein a locking member capable of locking movement of the supporting member in a state where the ND filter does not shield the aperture is arranged in a portion of the base member where the one end of the supporting member is positioned.

5. The shutter-driving device combined with a diaphragm according to claim 4,
wherein the supporting member is elastically biased by a first elastic member in a direction in which the ND filter shields the aperture and the locking member elastically biased by a second elastic member elastically contacts an end of the supporting member so that the ND filter in a state where the aperture is not shielded is locked.

6. The shutter-driving device combined with a diaphragm according to claim 5,
wherein the biasing force of the second elastic member is larger than the biasing force of the first elastic member.

7. The shutter-driving device combined with a diaphragm according to claim 4,
wherein, when the locking of the supporting member by the locking member is released, the ND filter moves from a position in which the aperture is not shielded to a position in which the aperture is shielded by the biasing force of the first elastic member.

8. The shutter-driving device combined with a diaphragm according to claim 4,
wherein an unlocking portion capable of rotating the driving ring in a direction in which the light-adjusting member closes the aperture so that the locked supporting member is pressed to release the locking of the supporting member is formed in the driving ring.

9. The shutter-driving device combined with a diaphragm according to claim 4,
wherein the supporting member rotates in synchronization with rotation of the driving ring in a direction in which the light-adjusting member opens the aperture so that the ND filter moves from a position in which the aperture is shielded to a position in which the aperture is not shielded.

10. The shutter-driving device combined with a diaphragm according to claim 3,
wherein an operation pin capable of moving the ND filter from a state where the aperture is shielded to a position in which the aperture is not shielded against a biasing force of a first elastic member is formed in the driving ring.

11. The shutter-driving device combined with a diaphragm according to claim 3,
wherein the driving source includes an electro-magnetic actuator, and
wherein the driving ring rotates at a predetermined angle of rotation in cooperation with a reciprocating motion of a driving lever directly connected to the driving source in one direction and in another.

12. The shutter-driving device combined with a diaphragm according to claim 11,
wherein an engaging groove with which the driving lever engages is formed in the driving ring,
wherein elongated holes with which protrusions formed in the driving ring engage are formed in the plurality of light-adjusting members,
wherein the driving lever engaging with the engaging groove of the driving ring engages with the elongated hole of one of the light-adjusting members, and
wherein the protrusions formed in the driving ring engage with the elongated holes of the remaining light-adjusting members.
